(19) United States
(12) Patent Application Publication
(10) Pub. No.: US 2016/0090760 A1
(43) Pub. Date: Mar. 31, 2016

(54) Falling Freight Restraint System

(71) Applicant: Alan Rettig, Munford, TN (US)

(72) Inventor: Alan Rettig, Munford, TN (US)

(21) Appl. No.: 14/499,378

(22) Filed: Sep. 29, 2014

(51) Int. Cl. E05C 17/02

(52) U.S. Cl. CPC E05C 17/02

(57) ABSTRACT

A falling freight restraint system for trailers and cargo containers that prevents freight that is leaning against door from forcing the door open and possibly falling out, which could otherwise cause injury to the person who opens the door or damage to the freight.

### CROSS-REFERENCE TO RELATED APPLICATIONS

| | | |
|---|---|---|
| 3,625,544 | December, 1971 | Goodwin et al. |
| 3,871,694 | February, 1973 | White |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC

Not Applicable

### DESCRIPTION

1. Field of the Invention

A falling freight restraint system for use on the side by side or single hinged doors of trailers and cargo containers which includes two plate systems, one plate system attached to first opening door and the second plate system attached to the opposing door or the side of the trailer or cargo container. Between the two plate systems is a detachable cable that allows the door of the trailer to be opened but which prevents the doors from being forced open. The operator can then peer into the trailer or cargo container to determine whether the load contained therein has shifted or might fall out when the doors are fully opened. Once it is determined that the doors are safe to open, the cable can be detached so that the cargo can be unloaded. The attachment point may also include a sensor that identifies when the cable is properly attached and which causes the breaks of the trailer to be locked when the cable is not properly attached, thus preventing the trailer from moving unless the cable is properly engaged.

2. Background of the Invention

Loads contained in trailers and cargo containers can shift during transport. However, the person who opens the container cannot see inside the trailer or cargo container prior to opening and thus may not know whether the load has shifted or whether said is load propped against the door and may fall out upon the opening of said door. This shifting or falling freight poses a safety risk to the person opening the door and if the freight falls, it may be damaged. The present disclosure provides a method of creating a safe environment where the doors of a trailer or cargo container can be partially opened to allow the contents inside said trailer or cargo container to be checked for shifting, while preventing the doors from being forced open from the load contained inside.

In U.S. Pat. No. 3,625,544, Goodwin et al., discloses a truck-trailer rear door protector that restricts the size of compartment within the trailer by creating a movable bulkhead attached to the top, sides and floor of the trailer, thus ensuring that the load cannot shift against the rear doors, whereas the present disclosure creates a method of preventing the doors from being forced open by cargo that may have shifted against the doors.

In U.S. Pat. No. 3,871,694, White, discloses the general means by which trailer and cargo container doors are secured, whereas the present disclosure provides a method of safely opening trailer doors and preventing the freight contained within the trailer from falling out.

### SUMMARY OF THE INVENTION

A falling freight restraint system for safely opening the doors of trailers and cargo containers where the doors of said trailers and cargo containers are side by side doors hinged to open horizontally or a single hinged door hinged to open horizontally.

In the first embodiment for side by side doors, there are two plate systems, the first, right plate system, is attached to the right door and the second, left plate system, is attached to the left door. The right plate system is comprised of a right exterior plate on the outside of the trailer or cargo container right door and a right interior plate for reinforcement. The right exterior plate and the right interior plate of the right plate system are connected by a plurality of fastening means that pass through the right exterior plate, through the right side door, and through the right interior plate. Attached to the right plate system on the right exterior plate is a cable means and on the end of the cable means that is not attached is a connecting means. The left plate system is comprised of a left exterior plate on the outside of the trailer or cargo container and a left interior plate for reinforcement. The left exterior plate and the left interior plate of the left plate system are connected by a plurality of fastening means that pass through the left exterior plate, through the left side door, and through the left interior plate. Attached to the left exterior plate is an attachment means to which the connecting means of the cabling means can be attached. The cabling means is long enough to allow the right door to be opened and allow the person who opens the door to peer into the trailer or cargo container to determine if something is propped against the door. If something is propped against the rear door, the cabling means prevents the door from swinging open by the weight of the freight. Once it is determined that nothing is propped against the door, the connecting means of the cabling means can be detached from the left plate and the door fully opened.

In the second embodiment for side by side doors, there are two plate systems, the first, right plate system, is attached to the right door and the second, left plate system, is attached to the left door. The right plate system is comprised of a right exterior plate on the outside of the trailer or cargo container right door and a right interior plate for reinforcement. The right exterior plate and the right interior plate of the right plate system are connected by a plurality of fastening means that pass through the right exterior plate, through the right side door, and through the right interior plate. The left plate system is comprised of a left exterior plate on the outside of the trailer or cargo container and a left interior plate for reinforcement. The left exterior plate and the left interior plate of the left plate system are connected by a plurality of fastening means that pass through the left exterior plate, through the left side door, and through the left interior plate. Attached to the right plate system on the right exterior plate is an attachment means to which the connecting means of the cabling means can be attached. Attached to the left exterior plate is a cable means and on the end of the cable means that is not attached is a connecting means. The cabling means is long enough to allow the right door to be opened and allow the person who opens the door to peer into the trailer or cargo container to determine if something is propped against the door. If something is propped against the rear door, the cabling means prevents the door from swinging open by the weight of the freight. Once it is determined that nothing is propped against the door, the connecting means of the cabling means can be detached from the left plate and the door fully opened.

In the first embodiment for a single hinged door, there is a door plate system attached to the door, and a sidewall plate system attached to the sidewall of the trailer or cargo container. The door plate system comprises a door exterior plate attached to the outside of the door and a door interior plate for reinforcement. The door exterior plate and the door interior plate of the door plate system are connected by a plurality of fastening means that pass through the door exterior plate, through the door, and through the door interior plate. The sidewall plate system comprises a sidewall exterior plate on the exterior sidewall of the trailer or cargo container and a sidewall interior plate for reinforcement. The sidewall exterior plate and the sidewall interior plate of the sidewall plate system are connected by a plurality of fastening means that pass through the sidewall exterior plate, through the sidewall, and through the sidewall interior plate. Attached to the sidewall exterior plate is a cable means and at the end of the cabling means that is not attached to the right exterior plate is a connecting means. Attached to the door plate system is an attachment means to which the connecting means of the cabling means can be attached. The cabling means is long enough to allow the door to be opened and allow the person who opened the door to peer into the trailer or cargo container to determine if something is propped against the door. If something is propped against the rear door, the cabling means prevents the door from swinging open by the weight of the freight. Once it is determined that nothing is propped against the door, the cabling means can be detached from the left plate and the door fully opened.

In the second embodiment for a single hinged door, there is a door plate system attached to the door, and a sidewall plate system attached to the sidewall of the trailer or cargo container. The door plate system comprises a door exterior plate attached to the outside of the door and a door interior plate for reinforcement. The door exterior plate and the door interior plate of the door plate system are connected by a plurality of fastening means that pass through the door exterior plate, through the door, and through the door interior plate. Attached to the door plate system is a cable means and at the end of the cabling means that is not attached to the right exterior plate is a connecting means. The sidewall plate system comprises a sidewall exterior plate on the exterior sidewall of the trailer or cargo container and a sidewall interior plate for reinforcement. The sidewall exterior plate and the sidewall interior plate of the sidewall plate system are connected by a plurality of fastening means that pass through the sidewall exterior plate, through the sidewall, and through the sidewall interior plate. Attached to the sidewall exterior plate is an attachment means to which the connecting means of the cabling means can be attached. The cabling means is long enough to allow the door to be opened and allow the person who opened the door to peer into the trailer or cargo container to determine if something is propped against the door. If something is propped against the rear door, the cabling means prevents the door from swinging open by the weight of the freight. Once it is determined that nothing is propped against the door, the cabling means can be detached from the left plate and the door fully opened.

Where the falling freight restraint system is used with a trailer, a stopping means can be included whereby when the cabling means is not connected to both plates, the break system of the trailer is locked, preventing the trailer from being moved.

### BRIEF DESCRIPTION OF THE SEVERAL VIEWS OF THE DRAWING

FIG. 1 is a view of the first embodiment for side by side doors hinged to open horizontally, displaying the right plate system and the left plate system, with the cabling means extending from the right plate system and the attachment means attached to the left plate system;

FIG. 2A is a cross sectional view of the first embodiment for side by side doors hinged to open horizontally displaying the exterior plate and interior plate of the left door, indicating the attachment means, as well as the plurality of fastening means;

FIG. 2B is a cross sectional view of the first embodiment for side by side doors hinged to open horizontally displaying the exterior plate and interior plate of the right door, indicating the cabling means and the connecting means, as well as the plurality of fastening means;

FIG. 3 is a view of the second embodiment for side by side doors hinged to open horizontally, displaying the right plate system and the left plate system, with the attachment means attached to the right plate system and the cabling means extending from the left plate system;

FIG. 4A is a cross sectional view of the second embodiment for side by side doors hinged to open horizontally displaying the exterior plate and interior plate of the left door, indicating the cabling means and the connecting means, as well as the plurality of fastening means;

FIG. 4B is a cross sectional view of the second embodiment for side by side doors hinged to open horizontally displaying the exterior plate and interior plate of the right door, indicating the attachment means, as well as the plurality of fastening means;

FIG. 5 is a view of the first embodiment for a single hinged door, indicating the door plate system, the sidewall plate system, with the attachment means attached to the door plate system and the cabling means extending from the sidewall plate system;

FIG. 6A is a cross sectional view of the first embodiment for a single hinged door displaying the exterior plate and interior plate of the door plate, indicating the attachment means, as well as the plurality of fastening means;

FIG. 6B is a cross sectional view of the first embodiment for a single hinged door displaying the sidewall exterior plate and sidewall interior plate, indicating the cabling means and the connecting means, as well as the plurality of fastening means;

FIG. 7 is a view of the second embodiment for a single hinged door, indicating the door plate system, the sidewall plate system, with the cabling means extending from the door plate system and the attachment means attached to the sidewall plate system;

FIG. 8A is a cross sectional view of the second embodiment for a single hinged door displaying the exterior plate and interior plate of the door plate, indicating the cabling means and the connecting means, as well as the plurality of fastening means; and

FIG. 8B is a cross sectional view of the second embodiment for a single hinged door displaying the sidewall exterior plate and sidewall interior plate, indicating the attachment means, as well as the plurality of fastening means.

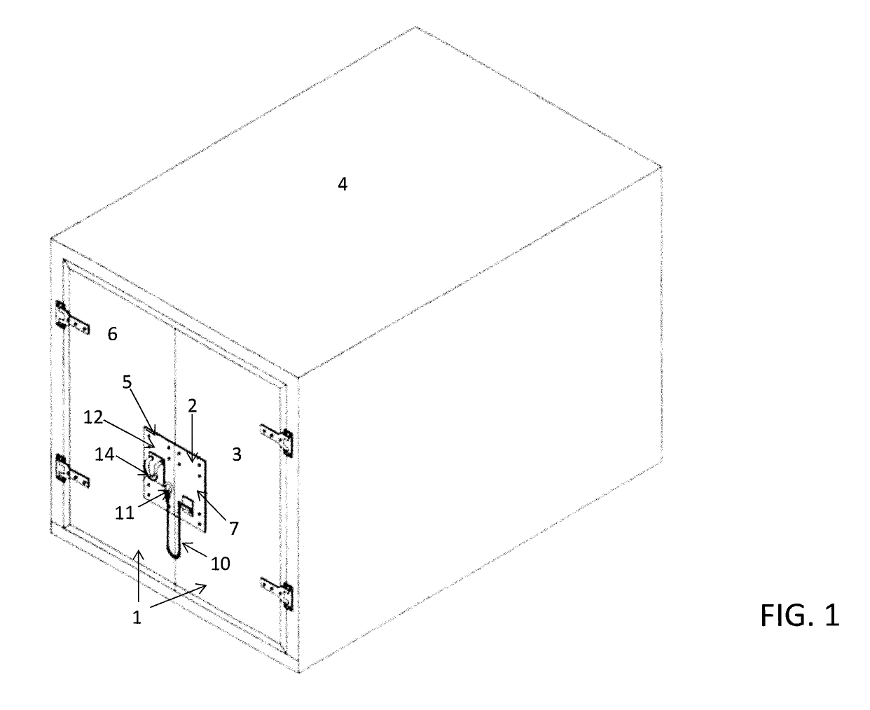

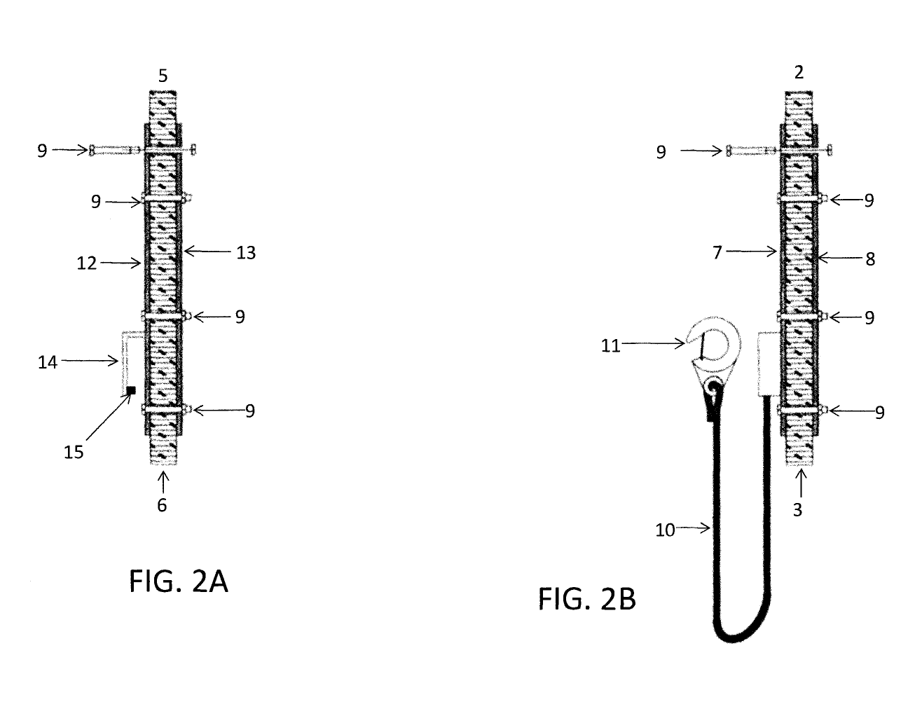

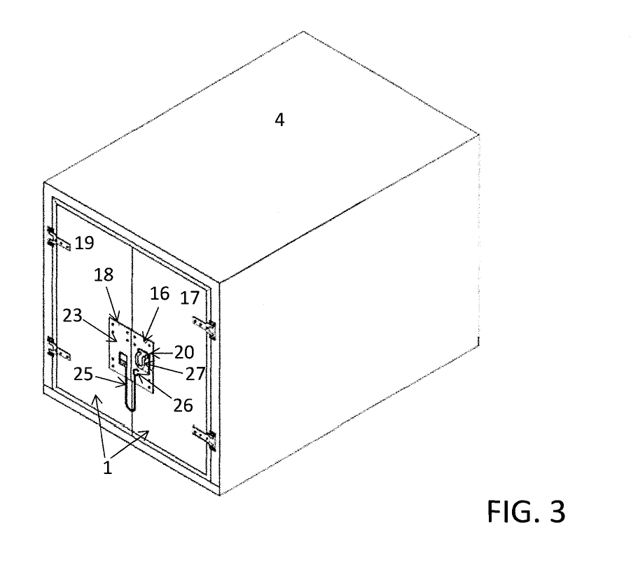

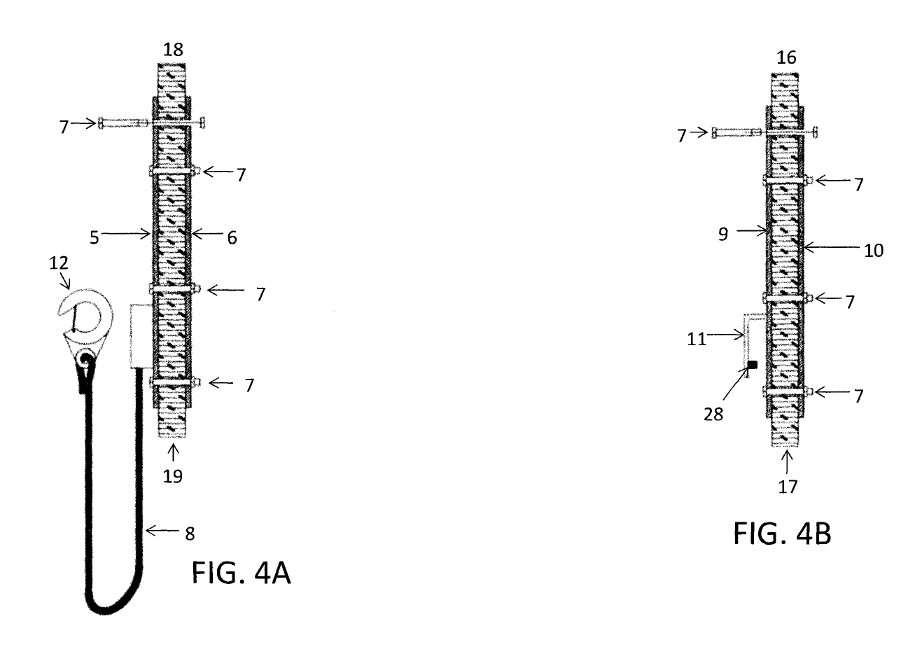

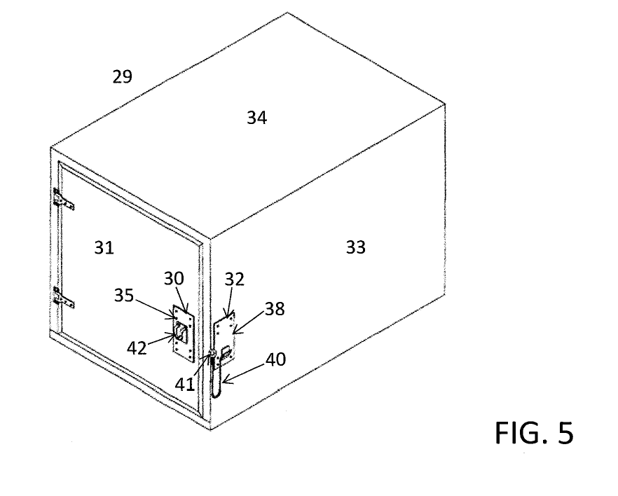

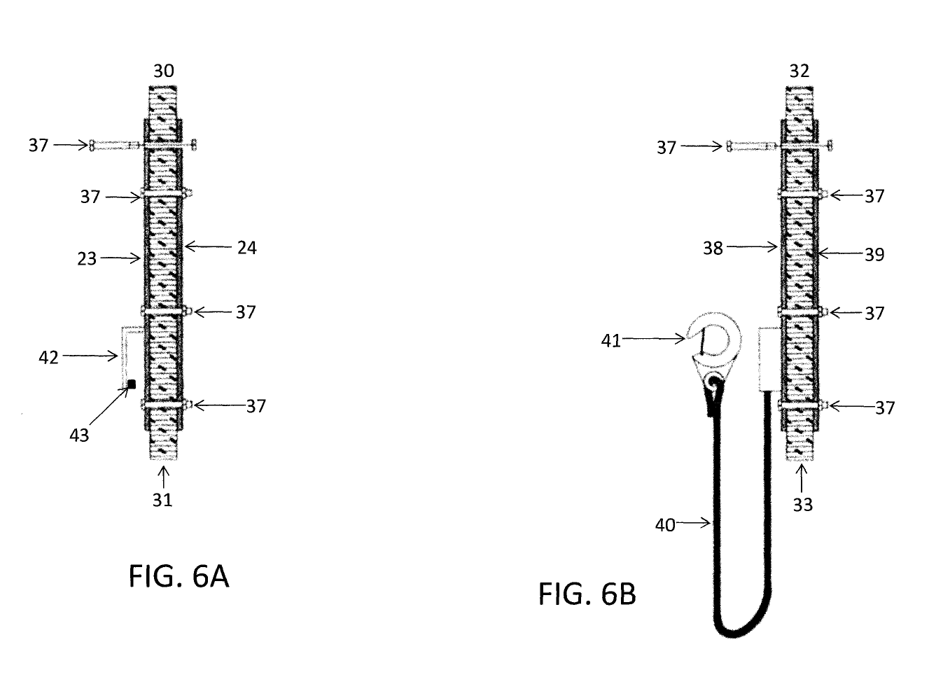

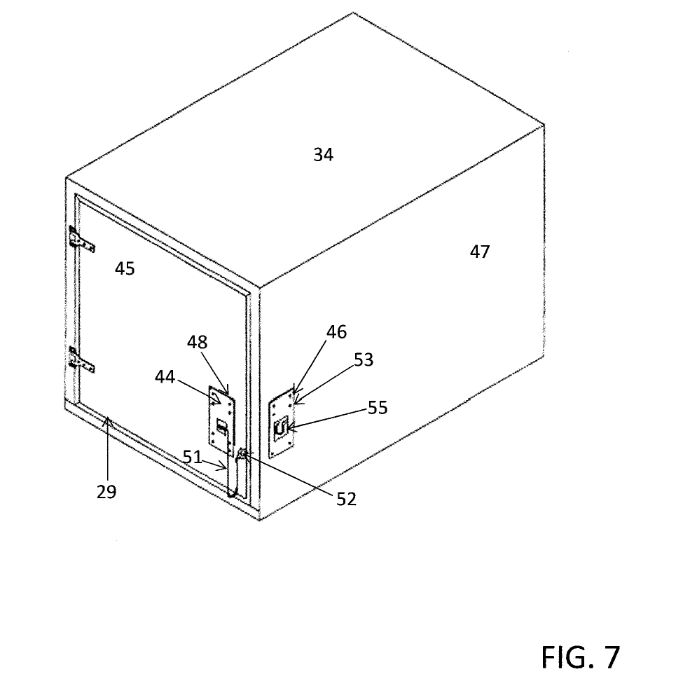

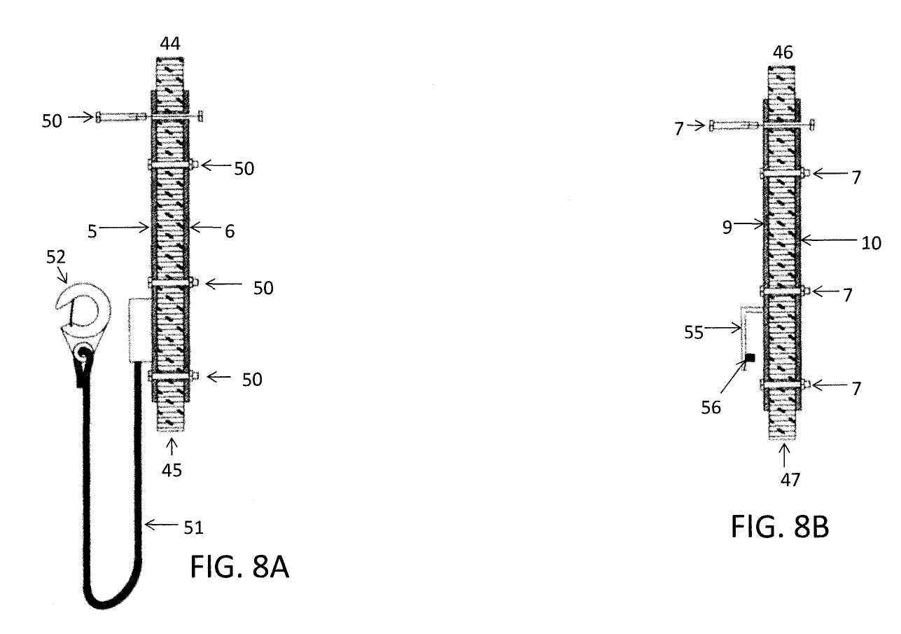

### DETAILED DESCRIPTION OF THE INVENTION

A falling freight restraint system for preventing freight inside trailers and cargo containers from forcing the door of the freight or cargo container open that otherwise might result in injury to the person who opens the door or damage to the freight, said method being applicable for side by side doors hinged that opens horizontally or a single hinged door hinged that opens horizontally.

The first embodiment for side by side doors 1 comprises a right plate system 2 attached to the right door 3 of the trailer or cargo container 4 and a left plate system 5 attached to the left door 6 of the trailer or cargo container 4. The right plate system 2 is comprised of a right exterior plate 7 on the outside of the trailer or cargo container right door 3 and a right interior plate 8 on the inside of the trailer or cargo container right door 3, for reinforcement. The right exterior plate 7 and the right interior plate 8 of the right plate system 2 are connected by a plurality of fastening means 9 that pass through the right exterior plate 7, through the right door 3, and through the right interior plate 8. Attached to the right plate system 2 on the right exterior plate 7 is a cabling means 10 with a connecting means 11 at the unattached end of the cabling means 10. The left plate system 5 is comprised of a left exterior plate 12 on the outside of the trailer or cargo container left door 6 and a left interior plate 13 on the inside of the trailer or cargo container left door 6, for reinforcement. The left exterior plate 12 and the left interior plate 13 of the left plate system 5 are connected by a plurality of fastening means 9 that pass through the left exterior plate 12, through the left door 6, and through the left interior plate 13. Attached to the left exterior plate 12 is an attachment means 14 to attach the connecting means 11 of the cabling means 10 to the left plate system 5. The cabling means 10 is long enough so that when the cabling means 10 is attached to the attachment means 14, the right door 3 can be opened to allow the person who opens the right door 3 to peer into the trailer or cargo container 4 to determine if something is propped against the right door 3 but impedes the right door 3 from fully opening.

In an additional embodiment, the attachment means 14 includes a sensor means 15, whereby said sensor means 15 can detect when the connecting means 11 is properly attached so that unless the connecting means 11 is properly attached, the break system of the trailer is locked and the trailer cannot be moved.

The second embodiment for side by side doors 1 comprises a right plate system 16 attached to the right door 17 of the trailer or cargo container 4 and a left plate system 18 attached to the left door 19 of the trailer or cargo container 4. The right plate system 16 is comprised of a right exterior plate 20 on the outside of the trailer or cargo container right door 17 and a right interior plate 21 on the inside of the trailer or cargo container right door 17 for reinforcement. The right exterior plate 20 and the right interior plate 21 of the right plate system 16 are connected by a plurality of fastening means 22 that pass through the right exterior plate 20, through the right door 17, and through the right interior plate 21. The left plate system 18 is comprised of a left exterior plate 23 on the outside of the trailer or cargo container left door 19 and a left interior plate 24 on the inside of the trailer or cargo container left door 19 for reinforcement. The left exterior plate 23 and the left interior plate 24 of the left plate system 18 are connected by a plurality of fastening means 22 that pass through the left exterior plate 23, through the left door 19, and through the left interior plate 24. Attached to the left plate system 18 on the left exterior plate 23 is a cable means 25 with a connecting means 26 at the unattached end of the cable means 25. Attached to the right exterior plate 20 is an attachment means 27 to attach the connecting means 26 of the cabling means 25 to the right plate system 16. The cabling means 25 is long enough, so that, when the connecting means 26 is attached to the attachment means 27, the right door 17 can be opened to allow the person who opens the right door 17 to peer into the trailer or cargo container to determine if something is propped against the right door 17 but impedes the right door 17 from fully opening.

In another embodiment, the attachment means 27 includes a sensor means 28, whereby said sensor means 28 can detect when the connecting means 26 is properly attached so that unless the connecting means 26 is properly attached, the break system of the trailer is locked and the trailer cannot be moved.

The first preferred embodiment for single hinged doors 29 comprises a door plate system 30 attached to the door 31 of the trailer or cargo container 34, and a sidewall plate system 32 attached to the sidewall 33 of the trailer or cargo container 34. The door plate system 30 comprises a door exterior plate 35 attached to the outside of the door 31 and a door interior plate 36 attached to the inside of the door 31 for reinforcement. The door exterior plate 35 and the door interior plate 36 of the door plate system 30 are connected by a plurality of fastening means 37 that pass through the door exterior plate 35, through the door 31, and through the door interior plate 36. The sidewall plate system 32 comprises a sidewall exterior plate 38 on the outside of the sidewall 33 of the trailer or cargo container 34 and a sidewall interior plate 39 on the inside of the sidewall 33 of the trailer or cargo container 34 for reinforcement. The sidewall exterior plate 38 and the sidewall interior plate 39 of the sidewall plate system 32 are connected by a plurality of fastening means 37 that pass through the sidewall exterior plate 38, through the sidewall 33 of the trailer or cargo container 34, and through the sidewall interior plate 39. Attached to the sidewall exterior plate 38 is a cabling means 40 with a connecting means 41 at the unattached end of the cabling means 40. The door exterior plate 35 has an attachment means 42 to attach the connecting means 41 to the door plate system 30. The cabling means 40 is long enough to allow the door 31 to be opened and allow the person who opened the door 31 to peer into the trailer or cargo container 34 to determine if something is propped against the door 31. If something is propped against the door 31, the cabling means 40 prevents the door 31 from swinging open by the weight of the freight. Once it is determined that nothing is propped against the door 31 the connecting means 41 can be detached from the sidewall plate system 32 and the door 31 fully opened.

In an additional embodiment, the attachment means 42 also includes a sensor means 43, whereby said sensor means 43 can detect when the connecting means 41 is properly attached so that unless the connecting means 41 is properly attached, the break system of the trailer is locked and the trailer cannot be moved.

The second preferred embodiment for single hinged doors 29 comprises a door plate system 44 attached to the door 45 of the trailer or cargo container 34, and a sidewall plate system 46 attached to the sidewall 47 of the trailer or cargo container 34. The door plate system 44 comprises a door exterior plate 48 on the outside of the door 45 of the trailer or cargo container 34 and a door interior plate 49 on the inside of the door 45 of the trailer or cargo container 34 for reinforcement. The door exterior plate 48 and the door interior plate 49 of the door plate system 44 are connected by a plurality of fastening means 50 that pass through the door exterior plate 48, through the door 45 of the trailer or cargo container 34, and through the door interior plate 49. Attached to the door exterior plate 48 is a cable means 51 with a connecting means 52 at the unattached end of the cable means 51. The sidewall plate system 46 comprises a sidewall exterior plate 53 attached to the outside of the sidewall 47 and a sidewall interior plate 54 attached to the inside of the sidewall 47 for reinforcement. The sidewall exterior plate 53 and the sidewall interior plate 54 of the sidewall plate system 46 are connected by a plurality of fastening means 50 that pass through the sidewall exterior plate 53, through the sidewall 47 and through the sidewall interior plate 54. The sidewall exterior plate 53 has an attachment means 55 to attach the connecting means 52 to the sidewall plate system 46. The cabling means 51 is long enough to allow the door 45 to be opened and allow the person who opened the door 45 to peer into the trailer or cargo container 34 to determine if something is propped against the door 45. If something is propped against the door 45, the cabling means 51 prevents the door 45 from swinging open by the weight of the freight. Once it is determined that nothing is propped against the door 45, the connecting means 52 can be detached from the attachment means 55 and the door 45 fully opened.

In an additional embodiment, the attachment means 55 also includes a sensor means 56, whereby said sensor means 56 can detect when the connecting means 52 is properly attached so that unless the attachment means 52 is properly attached, the break system of the trailer is locked and the trailer cannot be moved.

What is claimed:

1. A falling freight restraint system for a trailer or cargo container with side by side doors hinged to open horizontally comprising:
a right plate system attached to the right door of the trailer or cargo container and a left plate system attached to the left door of the trailer or cargo container;
the right plate system comprising an right exterior plate on the outside of the right door of the trailer or cargo container and a right interior plate on the inside of the right door of the trailer or cargo container;
where the right exterior plate and the right interior plate are connected by a plurality of fastening means that pass through the right exterior plate, through the right door and through the right interior plate;
where attached to the right exterior plate is a cabling means;
where on the end of the cabling means that is not attached to the right exterior plate there is a connecting means;
the left plate system comprising a left exterior plate on the outside of the left door of the trailer or cargo container and a left interior plate on the inside of the left door of the trailer or cargo container;
where the left exterior plate and the left interior plate are connected by a plurality of fastening means that pass through the left exterior plate, through the right door and through the left interior plate;
where there is an attachment means on the left exterior plate where the connecting means of the cabling means can be attached to the left plate system; and
where the cabling means is long enough to allow a person to open the right door and look inside the trailer or cargo container to see if freight has shifted or fallen against the door while preventing the right door from fully opening.

2. The falling freight restraint system of claim 1 where the attachment means also includes a sensor means such that the sensor detects when the connecting means is properly attached to the attachment means and if the connecting means is not properly attached to the attachment means, the breaking system of the trailer is locked and the trailer cannot be moved.

3. A falling freight restraint system for a trailer or cargo container with side by side doors hinged to open horizontally comprising:
a right plate system attached to the right door of the trailer or cargo container and a left plate system attached to the left door of the trailer or cargo container;
the right plate system comprising an right exterior plate on the outside of the right door of the trailer or cargo container and a right interior plate on the inside of the right door of the trailer or cargo container;
where the right exterior plate and the right interior plate are connected by a plurality of fastening means that pass through the right exterior plate, through the right door and through the right interior plate;
the left plate system comprising a left exterior plate on the outside of the left door of the trailer or cargo container and a left interior plate on the inside of the left door of the trailer or cargo container;
where the left exterior plate and the left interior plate are connected by a plurality of fastening means that pass through the left exterior plate, through the right door and through the left interior plate;
where attached to the left exterior plate is a cabling means;
where on the end of the cabling means that is not attached to the left exterior plate there is a connecting means;
where attached to the right exterior plate is an attachment means where the connecting means of the cabling means can be attached to the right plate system; and
where the cabling means is long enough to allow a person to open the right door and look inside the trailer or cargo container to see if freight has shifted or fallen against the door while preventing the right door from fully opening.

4. The falling freight restraint system of claim 3 where the attachment means also includes a sensor means such that the sensor detects when the connecting means is properly attached to the attachment means and if the connecting means is not properly attached to the attachment means, the breaking system of the trailer is locked and the trailer cannot be moved.

5. A falling freight restraint system for a trailer or cargo container with single hinged doors that opens horizontally comprising:
a door plate system attached to the door of the trailer or cargo container and a sidewall plate system attached to the sidewall of the trailer or cargo container;
the door plate system comprising an door exterior plate on the outside of the door of the trailer or cargo container and a door interior plate on the inside of the door of the trailer or cargo container;
where the door exterior plate and the door interior plate are connected by a plurality of fastening means that pass through the door exterior plate, through the door and through the door interior plate;
the sidewall plate system comprising a sidewall exterior plate on the outside of the sidewall of the trailer or cargo container and a sidewall interior plate on the inside of the sidewall of the trailer or cargo container;
where the sidewall exterior plate and the sidewall interior plate are connected by a plurality of fastening means that pass through the sidewall exterior plate, through the sidewall of the trailer or cargo container and through the sidewall interior plate;
where attached to the sidewall exterior plate is a cabling means;
where on the end of the cabling means that is not attached to the sidewall exterior plate there is a connecting means;
where there is an attachment means on the door exterior plate where the connecting means of the cabling means can be attached to the door plate system; and
where the cabling means is long enough to allow a person to open the door and look inside the trailer or cargo container to see if freight has shifted or fallen against the door while preventing the right door from fully opening.

6. The falling freight restraint system of claim 5 where the attachment means also includes a sensor means such that the sensor detects when the connecting means is properly attached to the attachment means and if the connecting means is not properly attached to the attachment means, the breaking system of the trailer is locked and the trailer cannot be moved.

7. A falling freight restraint system for a trailer or cargo container with single hinged doors that opens horizontally comprising:
a door plate system attached to the door of the trailer or cargo container and a sidewall plate system attached to the sidewall of the trailer or cargo container;
the door plate system comprising an door exterior plate on the outside of the door of the trailer or cargo container and a door interior plate on the inside of the door of the trailer or cargo container;
where the door exterior plate and the door interior plate are connected by a plurality of fastening means that pass through the door exterior plate, through the door and through the door interior plate;
where attached to the door exterior plate is a cabling means;
where on the end of the cabling means that is not attached to the door exterior plate there is a connecting means;
the sidewall plate system comprising a sidewall exterior plate on the outside of the sidewall of the trailer or cargo container and a sidewall interior plate on the inside of the sidewall of the trailer or cargo container;
where the sidewall exterior plate and the sidewall interior plate are connected by a plurality of fastening means that pass through the sidewall exterior plate, through the sidewall of the trailer or cargo container and through the sidewall interior plate;
where there is an attachment means on the sidewall exterior plate where the connecting means of the cabling means can be attached to the sidewall plate system; and
where the cabling means is long enough to allow a person to open the door and look inside the trailer or cargo container to see if freight has shifted or fallen against the door while preventing the right door from fully opening.

8. The falling freight restraint system of claim 7 where the attachment means also includes a sensor means such that the sensor detects when the connecting means is properly attached to the attachment means and if the connecting means is not properly attached to the attachment means, the breaking system of the trailer is locked and the trailer cannot be moved.
